(19) United States
(12) Patent Application Publication
(10) Pub. No.: US 2024/0190024 A1
(43) Pub. Date: Jun. 13, 2024

(54) HAND STRUCTURE

(71) Applicant: TOYOTA JIDOSHA KABUSHIKI KAISHA, Toyota-shi (JP)

(72) Inventor: Kanako MORI SUZUKI, Toyota-shi (JP)

(73) Assignee: TOYOTA JIDOSHA KABUSHIKI KAISHA, Toyota-shi (JP)

(21) Appl. No.: 18/524,218

(22) Filed: Nov. 30, 2023

(30) Foreign Application Priority Data
Dec. 9, 2022 (JP) 2022-197056

(51) Int. Cl. B25J 15/10; B25J 19/00

(52) U.S. Cl. CPC B25J 15/103; B25J 19/0091

(57) ABSTRACT

A hand according to an aspect of the present disclosure includes a base portion, a finger joint portion provided at the base portion, a finger portion swingable about the finger joint portion, and a shock absorber coupled between the base portion and the finger portion to relieve rotational torque generated in the finger portion in response to a swing of the finger portion due to collision of a dynamic object. A plurality of the finger portions is provided for one base, and the shock absorber is connected between at least one of the finger portions and the base.

### CROSS-REFERENCE TO RELATED APPLICATION

This application claims priority to Japanese Patent Application No. 2022-197056 filed on Dec. 9, 2022, incorporated herein by reference in its entirety.

### BACKGROUND

### 1. Technical Field

The present disclosure relates to a hand structure.

### 2. Description of Related Art

In recent years, research and development of a robot hand imitating a human hand have been conducted. For example, Japanese Patent No. 5482664 (JP 5482664 B) discloses a robot hand including a hand portion and an arm portion. The hand portion corresponds to a portion corresponding to a wrist and the further portion of a human. The arm portion includes a driving unit configured by a plurality of motors, and generates a driving force for driving each movable portion of the hand portion. In the robot hand, a wrist-disposed pulley group disposed coaxially and an arm-portion pulley group disposed coaxially mesh with each other by a gear or the like, thereby transmitting the driving force generated by the driving unit to each movable portion of the hand portion.

### SUMMARY

It has been considered to control a dynamic object by using a finger, a hand, and an arm of a robot hand. However, because the robot hand has a rigid structure, it may be destroyed by collision with the dynamic object. In addition, since the dynamic object may bounce back at the moment of collision with the robot hand, it is difficult to control the object by the robot hand. On the other hand, when the robot hand is made of a flexible material such as an elastic body, it is difficult to apply a force to the object or control the object.

The present disclosure has been made in view of the above issue, and an object thereof is to provide a hand structure capable of controlling a dynamic object.

A hand structure according to an aspect of the present disclosure includes a base, a finger joint portion provided on the base, a finger portion that is swingable about the finger joint portion, and a shock absorber that is connected between the base and the finger portion to mitigate rotational torque generated in the finger portion in response to a swing of the finger portion due to collision of a dynamic object.

According to the present disclosure, it is possible to provide a hand structure capable of controlling a dynamic object.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a robot hand employing a hand structure according to an embodiment;

FIG. 2 is an enlarged view of a portion of the robotic hand of FIG. 1;

FIG. 3 is a diagram illustrating a ball launching operation performed by the robot hand according to the embodiment;

FIG. 4 is a diagram for explaining a ball launching operation by the robotic hand according to the embodiment; and

FIG. 5 is a diagram illustrating a ball launching operation performed by a robotic hand according to embodiment.

### DETAILED DESCRIPTION OF EMBODIMENTS

Hereinafter, embodiments of the present disclosure will be described with reference to the drawings. In order to clarify the explanation, the following description and drawings have been omitted or simplified as appropriate. In the drawings, the same elements are denoted by the same reference numerals, and redundant descriptions are omitted as necessary.

Embodiments relate to a hand structure applied to a robot hand (hereinafter, simply referred to as a “hand”). In the following description, the term “hand” refers to a portion corresponding to a human hand that is attached to the distal end of an arm of a human robot. Further, the “finger” of the hand means a portion corresponding to a finger of a human hand, and the “palm” of the hand means a portion corresponding to a palm of the human hand.

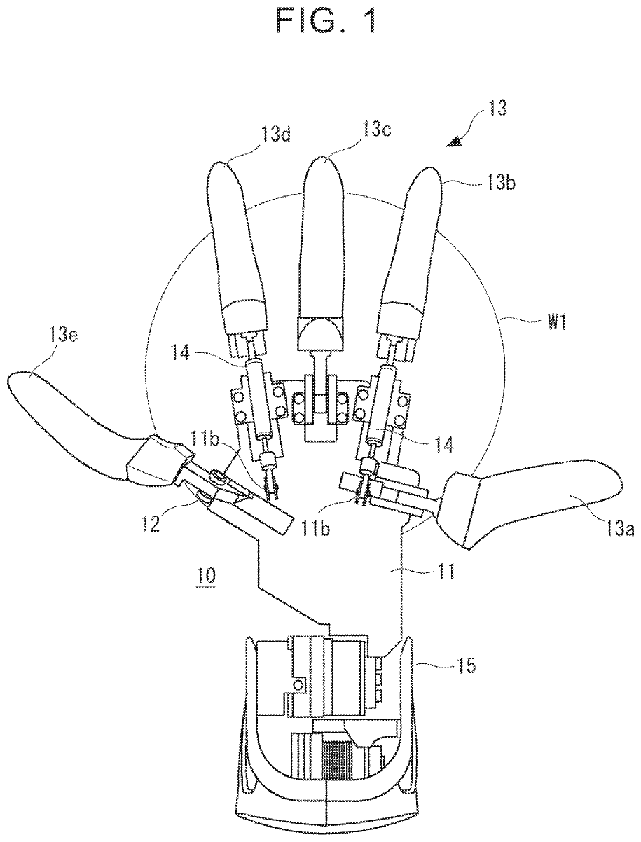

FIG. 1 is a diagram illustrating a schematic configuration of a hand 10 to which a hand structure according to an embodiment is applied. The hand 10 is applied, for example, to a humanoid robot capable of receiving, grasping, or hitting back a dynamic ball W1. Such a humanoid robot can perform an operation such as a dribble of a basketball in which ball W1 flying toward the palm of the hand 10 is received and hit by the hand 10. It should be noted that the humanoid robots are not limited to ball W1 and can receive other moving objects.

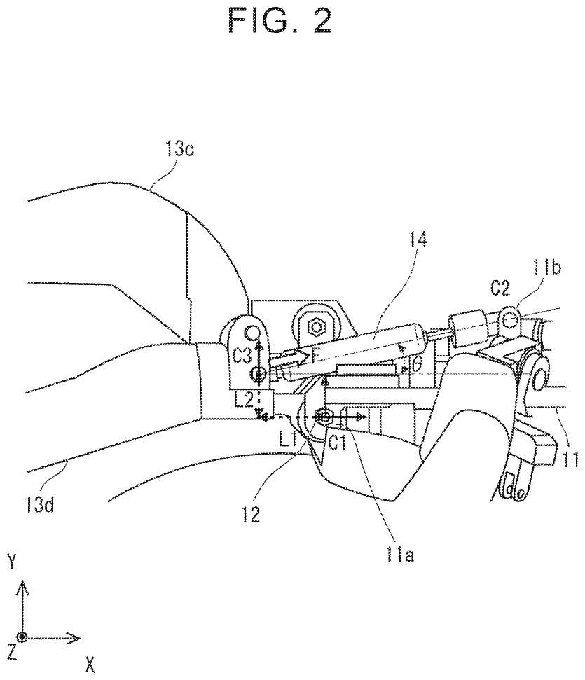

As illustrated in FIG. 1, the hand 10 includes a base 11, a finger joint portion 12, a finger portion 13, a shock absorber 14, and a wrist portion 15 as main components. In the embodiment illustrated in FIG. 1, five fingers such as a thumb 13a, an index finger 13b, a middle finger 13c, a ring finger 13d, and a little finger 13e are provided as the finger portions 13. When it is not necessary to distinguish these fingers, they are collectively referred to as a finger portion 13. FIG. 2 is an enlarged view of a portion of the hand 10 of FIG. 1. FIG. 2 is a side view of the ring finger 13d of FIG. 1.

The base 11 is a portion corresponding to the “palm”. Note that, unlike the palm of a human including a plurality of metacarpals, in the example shown in FIG. 1, the base 11 is formed of one member. However, the configuration of the base 11 is not limited to this, and may include members corresponding to a plurality of metacarpal bones.

Referring to FIG. 2, the base 11 is a substantially plate-shaped member in which the upper surface and the lower surface are parallel to each other. The upper surface of the base 11 corresponds to the back of the human hand, and the lower surface corresponds to the palm of the human hand. The base 11 is provided with a lower protruding portion 11a protruding from the lower surface thereof and an upper protruding portion 11b protruding from the upper surface thereof. Here, in FIG. 2, XYZ coordinates in which the left-right direction is the X direction, the up-down direction is the Y direction, and the direction perpendicular to the paper surface is the Z direction are applied. The upper and lower surfaces of the base 11 are parallel to XZ plane. The lower protruding portion 11a extends-Y from the end of the base 11. The upper protruding portion 11b extends in the +Y-direction from a position closer to the center than a position where the lower protruding portion 11a of the base 11 is provided.

Five lower projecting portions 11a are provided at predetermined intervals at the end portion of the base 11. Finger portions 13 are swingably connected to lower protruding portions 11a via respective finger joint portions 12. The finger joint portion 12 corresponds to the metacarpal phalangeal joint connecting the metacarpal bone and the proximal phalanx of the human palm. The finger joint portion 12 is, for example, a hinge joint. The finger portion 13 pivot relative to the base 11 about a hinge axis. The rotational center of the finger portion 13 is referred to as a C1. Note that the finger joint portion 12 is not limited to a hinge joint that rotates with a single hinge axis. For example, the finger joint portion 12 may be a ball/socket joint having more degrees of freedom than a hinge joint.

In the example shown in FIG. 1, each finger portion 13 is formed of one member, unlike a human finger composed of a plurality of phalanges, such as a finger portion 13, a distal phalanx, a middle phalanx, and a proximal phalanx. However, the configuration of the finger portion 13 is not limited to this, and may include a member corresponding to a plurality of phalanges.

The shock absorber 14 alleviates the rotational torque generated in the finger portion 13 in response to the swing of the finger portion 13 caused by the ball W1 colliding with the finger portion 13. As the shock absorber 14, a shock absorber, a gas spring, a rotary damper, a spring, or the like can be used. Hereinafter, an example in which a shock absorber that absorbs an impact by reciprocation of a rod in a cylinder filled with hydraulic oil is used as the shock absorber 14 will be described.

The shock absorber 14 is connected between at least one of the plurality of finger portions 13 and the base 11. In the embodiment shown in FIG. 1, a shock absorber 14 is connected between the index finger 13b and the ring finger 13d and the base 11. On the other hand, the shock absorber 14 is not connected to the thumb 13a, the middle finger 13c, and the little finger 13c.

Specifically, the upper protruding portion 11b is provided at a position corresponding to the index finger 13b and the ring finger 13d on the upper surface of the base 11. One end of the shock absorber 14 is connected to the upper protruding portion 11b. The other end of the shock absorber 14 is connected to the index finger 13b and the ring finger 13d, respectively, in the vicinity of the end portion connected to the finger joint portion 12. The stroke end of the reciprocating rod of the shock absorber 14 may be either the finger portion 13 side or the base 11 side.

Referring now to FIG. 2, the ring finger 13d will be described as a representation. As shown in FIG. 2, the connecting portion between one end of the shock absorber 14 and the upper protruding portion 11b is C2, and the connecting portion between the other end of the shock absorber 14 and the ring finger 13d is C3. The connecting portion C3 is located at a position separated from the rotational center C1 of the finger portion 13 by a distance L1 in −X direction and a distance L2 in the +Y direction. The hand 10 according to the embodiment has a linkage including a shock absorber 14, a ring finger 13d, and a rotational center C1 rotatably connecting the base 11.

The ball W1 flies from the palm of the hand 10. In the embodiment of FIG. 1, the index finger 13b provided with the shock absorber 14 and the ring finger 13d receive the ball W1. The ball W1 impinges on the index finger 13b and the belly of the ring finger 13d. As a result, the index finger 13b and the ring finger 13d are rotated around the rotational center C1. The shock absorber 14 can absorb an impact applied in the axial direction in response to the rotational torque by reciprocating movement of the rod in the cylinder filled with the hydraulic oil. As a result, the dynamic ball W1 is prevented from bouncing back at the moment when it collides with the finger portion 13, and the ball W1 can be received by the hand 10.

Let 0 be the intersection angle between the straight line in the X direction passing through the connecting portion C3 and the straight line passing through the connecting portion C2 and the connecting portion C3, that is, the extending direction of the shock absorber 14. The torque T applied to the rotational center C1 by the drag F exerted by the shock absorber 14 on the finger portion 13 is calculated by the following equation.

T=F(L1×sin θ+L2× cos θ)

If the position of the rotational center C1 and the position of the connecting portion C2, C3 are the positions where T is not 0 in the above equation, even if θ=0° or θ=90°, the shock absorber 14 can exert an impact absorbing effect.

The hand 10 can grasp the ball W1 after receiving the dynamic ball W1, using the thumb 13a, the middle finger 13c, and the little finger 13e without the shock absorber 14. When the humanoid robot includes the right and left hands 10, the ball W1 can be gripped by sandwiching the ball W1 with both the hands 10.

The wrist portion 15 connects the hand 10 and a robot arm (not shown). The wrist portion 15 includes a driving unit (not shown) such as a motor. The output shaft of the driving unit is connected to a wrist joint provided in the wrist portion 15, and generates a rotational driving force of the hand 10 around the wrist joint.

The driving unit accelerates the hand 10 while the finger joint portion 12 is rigid, thereby driving the ball W1. As an example, the driving unit may provide acceleration to the hand 10 to provide the maximum displacement that the shock absorber 14 may take. Specifically, the driving unit applies acceleration to the hand 10 so that the rod of the shock absorber moves to the stroke end and stops. When the shock absorber 14 is maximally displaced, the index finger 13b and the ring finger 13d can be regarded as rigid. As described above, by applying a force to the ball W1 by using the index finger 13b and the ring finger 13d which are rigid bodies, it is possible to apply a force to the ball W1 in an appropriate direction. As another example, the hand 10 may include a mechanism capable of locking the finger joint portion 12 at an arbitrary position. The driving unit may apply acceleration to the hand 10 while locking the finger joint portion 12 so that the finger joint portion 12 is in a rigid state.

It is preferable that the cushioning material 16 is provided on the ventral surface of the finger portion 13 contacting the ball W1. The cushioning material 16 increases the frictional force and forms a condition in which the ball W1 is more stably stationary. The cushioning material 16 is not particularly limited, but may be made of a rubber sheet or a synthetic resin material. Examples of the synthetic resin include polyethylene, polypropylene, polystyrene, and polyurethane.

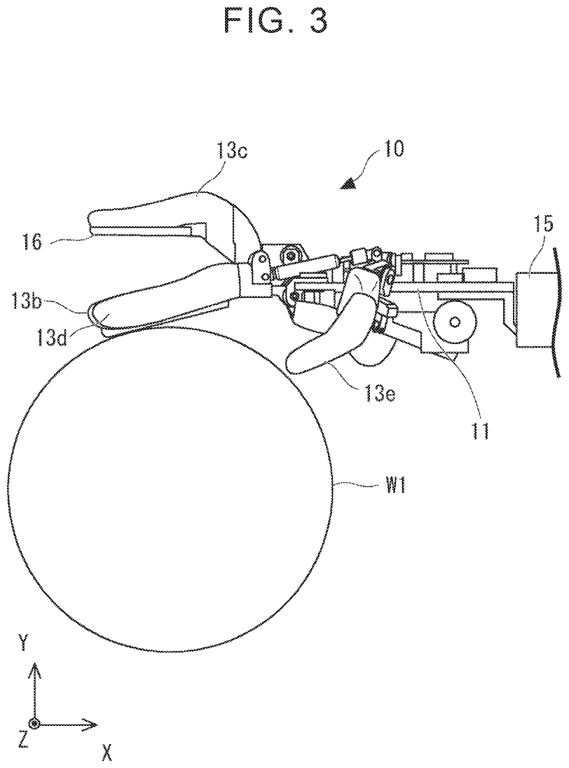

Here, referring to FIGS. 3 to 5, a ball W1 launching operation by the hand 10 will be described. FIG. 3 shows the dynamic ball W1 touching the index finger 13b and the ring finger 13d. The ball W1 flying from −Y in FIG. 3 contacts the cushioning material 16 provided on the ventral surface of the index finger 13b and the ring finger 13d. At this time, a force in the +Y-direction is applied to the index finger 13b and the ring finger 13d. As a result, the index finger 13b and the ring finger 13d swing in the +Y-direction about the rotational center C1.

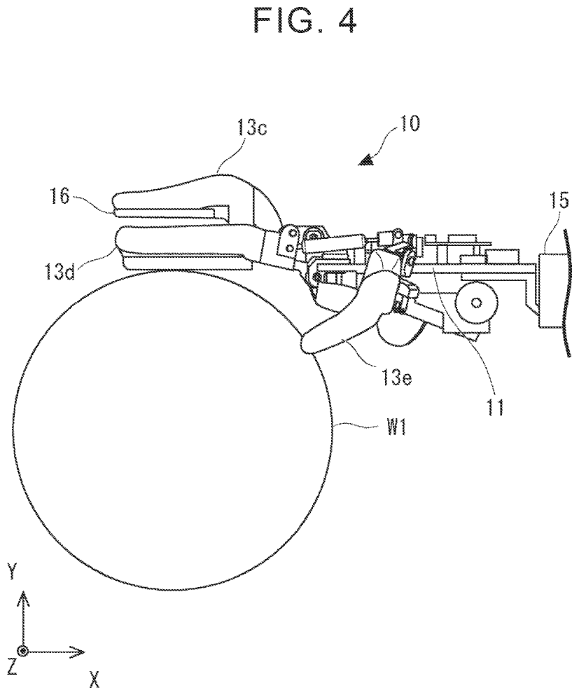

FIG. 4 shows that the impact of the ball W1 on the index finger 13b and the ring finger 13d is absorbed by the shock absorber 14. The shock absorber 14, which is connected to the index finger 13b and the ring finger 13d which are respectively swung in the +Y direction about the rotational center C1, is subjected to a force in a direction in which the shock absorber 14 extends, that is, in a direction along a straight line passing through the connecting portion C2, C3. This force causes the rod to move in the cylinder filled with hydraulic oil toward the stroke end. Accordingly, it is possible to reduce the rotational torque generated in the finger portion in response to the swing of the finger portion caused by the impact of the dynamic ball W1.

As described above, in the hand 10 of the embodiment, the ball W1 and the index finger 13b and the ring finger 13d remain in contact with each other until the ball W1 is at rest after the dynamic ball W1 first comes into contact with the index finger 13b and the ring finger 13d. During this time, the ball W1 can be controlled.

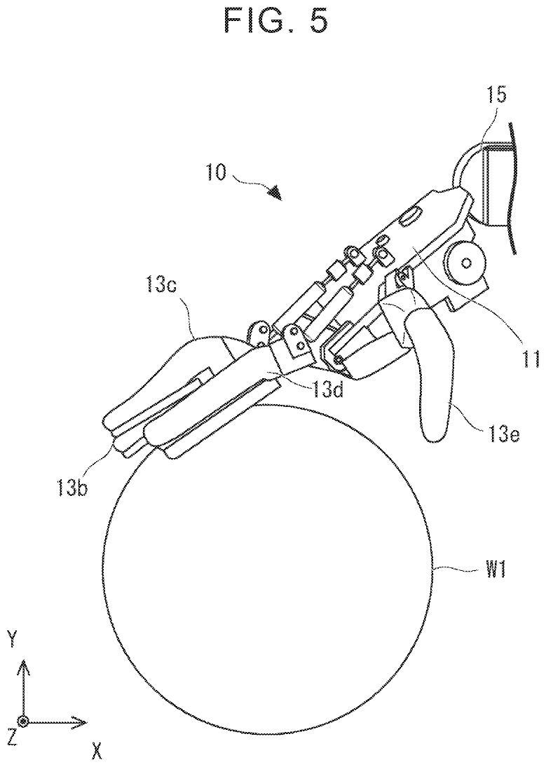

When the ball W1 is at rest, the hand 10 applies a force against the ball W1 in a direction opposite to the direction in which it has flew. FIG. 5 shows a state in which the hand 10 is rotationally driven around the wrist joint to launch a ball. First, the driving unit applies acceleration to the hand 10 to move the rod to the stroke end and stop the rod. The driving unit can then drive the hand 10 further to apply a force to the ball W1 and launch it while the shock absorber 14 is considered rigid.

This action of FIGS. 3 to 5 allows the hand 10 to hit the ball W1 back after receiving the dynamic ball W1. By repeating this operation, the humanoid robot including the hand 10 can perform an operation such as a dribble of a basketball.

In the above explanation, the operation of driving the ball W1 with the index finger 13b and the ring finger 13d is performed, but the present disclosure is not limited thereto. For example, the ball W1 may be launched by placing the dynamic ball W1 stationary and then applying a force to the ball W1 by the other thumb 13a, middle finger 13c, and little finger 13c.

The ball W1 may be held by the thumb 13a, the middle finger 13c, and the little finger 13e in which the shock absorber 14 is not provided, after the dynamic ball W1 is made stationary by the operations of FIGS. 3 and 4. Note that the thumb 13a, the middle finger 13c, and the little finger 13e can be transitioned to a state of gripping the ball W1 by a driving unit (not shown). When the ball W1 is gripped, the ball W1 is contacted with the cushioning material 16 provided on the ventral side of the thumb 13a, the middle finger 13c, and the little finger 13e. As a result, the ball W1 can be held stably.

The present disclosure is not limited to the above-described embodiments, and can be appropriately modified without departing from the spirit thereof. In the above embodiment, the shock absorber 14 is connected to the index finger 13b and the ring finger 13d, but the present disclosure is not limited thereto. The shock absorber 14 may be provided on any finger portion. The number of the shock absorbers 14 is not limited as long as the shock absorber 14 is provided in at least one finger portion. In the above embodiment, the hand structure is applied to a humanoid robot, but it may be applied to an industrial robot or the like.

What is claimed is:

1. A hand structure comprising:
a base;
a finger joint portion provided on the base;
a finger portion that is swingable about the finger joint portion; and
a shock absorber that is connected between the base and the finger portion to mitigate rotational torque generated in the finger portion in response to a swing of the finger portion due to collision of a dynamic object.

2. The hand structure according to claim 1, further comprising:
a wrist joint portion connected to the base; and
a driving unit configured to drive the base about the wrist joint portion, wherein
the driving unit applies acceleration to the base in a state where the finger joint portion becomes rigid after the object in contact with the finger portion becomes a stationary state, and serves the object.

3. The hand structure according to claim 1, wherein:
a plurality of the finger portions is provided for one base; and
the shock absorber is connected between at least one of the finger portions and the base.

4. The hand structure according to claim 3, further comprising a driving unit configured to drive the finger portion with respect to the base, wherein:
the finger portions include a finger portion to which the shock absorber is connected, and a finger portion to which the shock absorber is not connected; and
the driving unit drives the finger portion to which the shock absorber is not connected, and grips the object.

5. The hand structure according to claim 1, further comprising a cushioning material provided on a cushion side of the finger portion.
